(19) United States
(12) Patent Application Publication
(10) Pub. No.: US 2012/0205970 A1
(43) Pub. Date: Aug. 16, 2012

(54) DRIVE ARRANGEMENT FOR AN ELECTRIC BICYCLE

(75) Inventors: Christian Eckart, Vachendorf (DE); Martin Arnold, Georgensgmuend (DE); Martin Singhammer, Fridolfing (DE); Willem Blakborn, Inzell (DE)

(73) Assignee: ROSENBERGER HOCHFREQUENZTECHNK GMBH & CO. KG, Fridolfing (DE)

(21) Appl. No.: 13/390,365

(22) PCT Filed: Jul. 28, 2010
(86) PCT No.: PCT/EP10/04632

§ 371 Date: May 3, 2012

(30) Foreign Application Priority Data
Aug. 14, 2009 (DE) 20 2009 011 111.3

(51) Int. Cl. B60L 1/00; H02K 11/00

(52) U.S. Cl. 307/9.1; 310/71

(57) ABSTRACT

The present invention relates to a drive arrangement, that uses an electric motor, an energy source for electrical energy, and an energy transmission cable, which electrically connects the energy source to the electric motor and which performs this function as a coaxial cable.

This application is a National Stage filing based on PCT/EP2010/004632, filed Jul. 28, 2010, and which claims priority to German Patent Application No. DE 20 2009 011 111.3, filed Aug. 14, 2009.

### BACKGROUND OF THE INVENTION

1. Field of the Invention

The present invention relates to a drive arrangement having an electric motor, an energy source for electrical energy and an energy-transmitting cable which connects the energy source to the electric motor electrically. The invention also relates to a light electrical vehicle (LEV) and in particular an electric bicycle, and more specifically a pedelec (pedal electric cycle) or E-bike, having a drive arrangement. The invention also relates to a powered vehicle, and in particular a one-track or two-track powered vehicle, and more specifically an electric scooter, invalid carriage, moped (motor+pedal), motor cycle, or car.

2. Description of Related Art

Electric bicycles and, in this context, particularly pedelecs (pedal electric cycles, i.e., pedal-assisted electric cycles) are known from, for example, the publication entitled “E-Motion—Ein Spezial von Radfahren & ExtraEnergy.org” [“E-Motion—A special from Radfahren Magazine and the ExtraEnergy Association”], BVA Bielefelder Verlag, 2009, are meeting with an increasingly enthusiastic public response. On a pedelec, which in essence is constructed in the same way as a conventional bicycle with a pedal-equipped foot-power drive, there is provided an electric drive motor which is supplied by an energy source for electric energy and which, as a function of the force applied to the pedelec's pedals, provides a drive power additional to the muscle power. The electric motor is active when the pedals are pressed. The travel which the user experiences is like that with the wind behind him.

Another group of electric bicycles includes what are referred to as E-bikes. In this case the motor is active when a throttle is turned. Travel with the electric motor is possible in this case even without the pedals being pressed. Muscle power and the electric motor are systems which operate independently of one another. E-bikes can be ridden both purely electrically and in mixed operation.

Regardless of how the electric motor functions and operates, all such electric vehicles have a drive arrangement which has the electric motor and the electrical energy source. To transmit electrical energy from the energy source to the electric motor, the drive arrangement has an energy-transmitting cable which is electrically connected to the electric motor and the energy source. If required, there is also provided an electronic system which converts the voltage from the energy source to the operating voltage of the electric motor. Conventionally, these energy-transmitting cables take the form of two-core cables with suitable red and black color coding for the negative and positive sides of the voltage.

### SUMMARY OF THE INVENTION

Bearing in mind the problems and deficiencies of the prior art, it is therefore an object of the present invention to improve a drive arrangement of the above kind in respect of the space it takes up, its processability and its mechanical strength.

This object is achieved in accordance with the invention by a drive arrangement of the above kind having the features described herein and in the claims, by a light electrical vehicle (LEV) of the above kind, and by a powered vehicle having the features described herein and in the claims. Advantageous embodiments of the invention are further described below, and in the claims.

The above and other objects, which will be apparent to those skilled in the art, are achieved in the present invention which is directed to a drive arrangement comprising: a d.c. motor; an energy source for electrical energy; and an energy-transmitting cable connecting the energy source to the d.c. motor electrically, wherein the energy-transmitting cable includes a co-axial cable which comprising: at least one center conductor; at least one outer conductor; at least one insulator arranged between the center conductor and the outer conductor; and at least one electrically insulating sheath which surrounds the outer conductor, one outer conductor and one center conductor each being electrically connected to the energy source and the d.c. motor.

The co-axial cable is capable of transmitting high electrical currents equal to or greater than 30 A, or equal to or greater than 50 A, or may transmit voltages from 0 to 100V.

The energy source for electrical energy includes a battery, a storage battery, or a generator. The storage battery may comprise a nickel metal hybrid storage battery, a nickel-cadmium storage battery, a lead storage battery, or a lithium-ion storage battery.

The drive arrangement may include a motor control unit, the co-axial cable being used to transmit data in the form of high frequency signals from the motor control unit to the d.c. motor, or from the energy source to the motor control unit.

The drive arrangement may be in combination with a light electric vehicle (LEV), an electric bicycle, a pedelec (pedal electric cycle), or an E-bike a powered vehicle, a one-track or two-track powered vehicle, an electric scooter, an invalid carriage, a moped, a motor cycle, or a car.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a schematic view of a preferred embodiment of drive arrangement according to the invention; and

FIG. 2 is a view in section of region A in FIG. 1, taken on a line I-I in FIG. 1.

### DESCRIPTION OF THE PREFERRED EMBODIMENT(S)

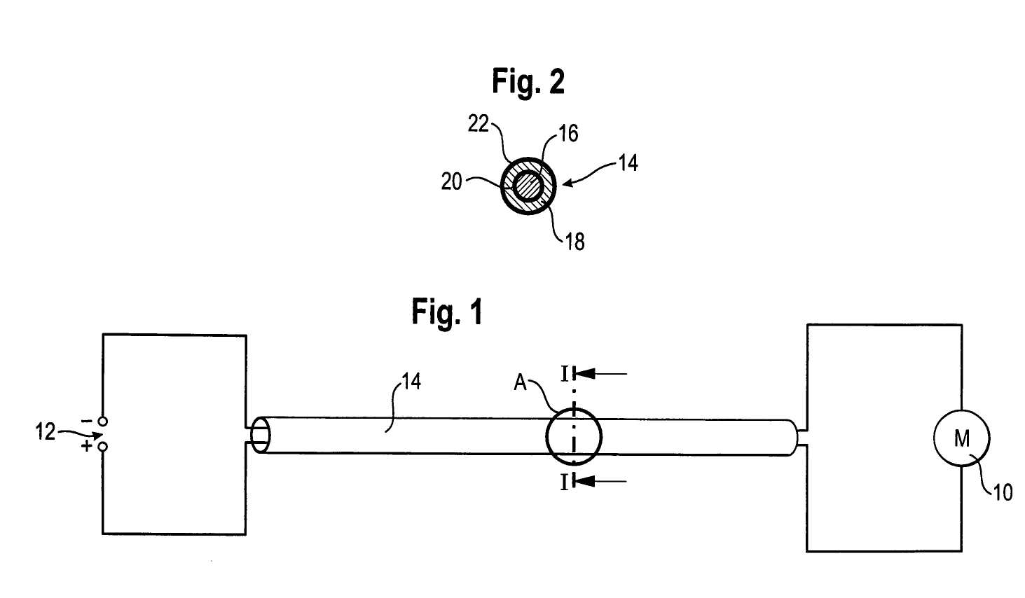

In describing the preferred embodiment of the present invention, reference will be made herein to FIGS. 1-2 of the drawings in which like numerals refer to like features of the invention.

In a drive arrangement of the above kind, provision is made in accordance with the invention for the energy-transmitting cable to take the form of a co-axial cable.

This has the advantage that a compact drive arrangement becomes available which requires little space for the energy-transmitting cable, the energy-transmitting cable having, at the same time, high mechanical strength. Co-axial cables can be processed and provided with plug-in connectors easily. At the same time, the energy-transmitting cable is screened against any unwanted coupling-in of high-frequency radiation. If desired, the energy-transmitting cable can also be used as a data transmission cable from the electric motor to a controlling electronic system without a further cable being required for this purpose.

A drive arrangement which is particularly compact and mechanically strong in respect of the energy-transmitting cable is obtained by virtue of the fact that the co-axial cable has at least one center conductor, at least one outer conductor, at least one insulator arranged between the center conductor and the outer conductor, and at least one electrically insulating sheath which surrounds the outer conductor.

Because the outer conductor and the center conductor are each connected to the energy source and the electric motor, the outer conductor is also used for transmitting energy and not simply as screening.

The electric motor is usefully a direct current (d.c.) motor or an alternating current (a.c.) motor.

A high drive power from the drive arrangement is obtained by designing the co-axial cable to transmit high electrical currents and in particular electrical currents equal to or greater than 30 A and in particular equal to or greater than 50 A.

A high torque from the drive arrangement is obtained by designing the co-axial cable for voltages of 0 to 100 V and in particular for 48 V.

A high energy density for the energy source is obtained by making the energy source for electrical energy a battery or a storage battery, and in particular a nickel metal hybrid storage battery, a nickel-cadmium storage battery, a lead storage battery, a lithium-ion storage battery, or a generator.

In a light electric vehicle (LEV) of the above kind, provision is made in accordance with the invention for the electric cycle to have a drive arrangement as described above.

This has the advantage that what becomes available is an LEV having a compact drive arrangement which requires little room for the energy-transmitting cable, the energy-transmitting cable having, at the same time, high mechanical strength. Co-axial cables can be processed and provided with plug-in connectors easily. At the same time, the energy-transmitting cable is screened against any unwanted coupling-in of high-frequency radiation. If desired, the energy-transmitting cable can also be used as a data transmission cable from the electric motor to a controlling electronic system without a further cable being required for this purpose.

In a powered vehicle of the above kind, provision is made in accordance with the invention for the powered vehicle to have a drive arrangement as described above.

This has the advantage that what becomes available is a powered vehicle having a compact drive arrangement which requires little room for the energy-transmitting cable, the energy-transmitting cable having, at the same time, high mechanical strength. Co-axial cables can be processed and provided with plug-in connectors easily. At the same time, the energy-transmitting cable is screened against any unwanted coupling-in of high-frequency radiation. If desired, the energy-transmitting cable can also be used as a data transmission cable from the electric motor to a controlling electronic system without a further cable being required for this purpose.

The preferred embodiment of drive arrangement according to the invention which is shown in FIG. 1 comprises an electric motor 10, an electrical energy source 12 and an energy-transmitting cable 14 which connects the electric motor 10 to the electrical energy source 12 electrically.

In accordance with the invention, the energy-transmitting cable 14 takes the form of a co-axial cable. As can be seen from FIG. 2, this co-axial cable comprises a center conductor 16 and an outer conductor 18 which surrounds the center conductor 16 co-axially, a dielectric 20 being arranged between the centre conductor 16 and the outer conductor 18. The co-axial cable 14 also has a sheath 22, made of an electrically insulating material, which surrounds the outer conductor.

The electric motor 10 is for example a d.c. motor and the co-axial cable 14 transmits a d.c. electrical current of an intensity of less than or equal to thirty amps (≦30 A) or less than or equal to fifty amps (≦50 A) from the electrical energy source 12 to the electric motor 10.

The electrical energy source 12 is preferably a lithium storage battery. It is however also possible for the electrical energy source 12 not to be a means of storing energy such as a battery or storage battery but to be an electrical generator which converts mechanical driving energy into electrical energy. This generator is for example an internal combustion engine.

It is particular advantageous for a electric vehicle, such for example as a pedelec or an E-bike, to be equipped with this drive arrangement because the co-axial cable 14 which is used as a power cable for transmitting energy from the electric energy storage source 12 to the electric motor 10 has mechanical properties in respect of thickness, strength in bending, insensitivity to ambient effects, life, and tear strength which are similar to, and sometimes better than, those of a Bowden cable used in bicycles. This co-axial cable 14 can therefore be fitted to the pedelec in the same way as a Bowden cable with no special precautions. At the same time, due to its construction, the co-axial cable 14 makes a power cable for transmitting high electrical powers from the electrical energy source 12 to the electric motor 10 available in a compact form, i.e., one which requires only a small amount of space. The amount of space required is considerably smaller than is required by the two-core power cables which would otherwise usually be used for these high electrical current intensities of up to thirty amps (30 A) or fifty amps (50 A), or more.

There are also a large number of devices and machines available for processing co-axial cables and assembling them, cutting them to length and providing them with connectors at their ends, and even doing so by automated processes and in large quantities.

In addition, what are also usually required in drive arrangements of this kind are cables for transmitting data in the form of high-frequency signals from for example a motor control unit to the electric motor 10 or from the electrical energy source 12 to the motor control unit. In a particularly advantageous way, the co-axial cable used as the power cable can be used in an identical form for this because it already has the screening and impedance required for transmitting high-frequency electrical signals. A supply of different types of cable therefore does not have to be kept available for data transmission and energy transmission and instead one and the same co-axial cable, merely fitted with different connectors, can be used. This simplifies production and assembly processes and the associated logistics.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A drive arrangement comprising:
a d.c. motor;
an energy source for electrical energy; and
an energy-transmitting cable connecting the energy source to the d.c. motor electrically, wherein the energy-transmitting cable includes a co-axial cable comprising:
at least one center conductor;
at least one outer conductor;
at least one insulator arranged between the center conductor and the outer conductor; and
at least one electrically insulating sheath which surrounds the outer conductor, one outer conductor and one center conductor each being electrically connected to the energy source and the d.c. motor.

2. The drive arrangement of claim 1 wherein the co-axial cable transmits high electrical currents equal to or greater than 30 A, or equal to or greater than 50 A.

3. The drive arrangement of claim 1, wherein the co-axial cable transmits voltages from 0 to 100 V.

4. The drive arrangement of claim 1 wherein the energy source for electrical energy includes a battery, a storage battery, or a generator.

5. The drive arrangement of claim 1, including a motor control unit, the co-axial cable transmitting data in the form of high frequency signals from the motor control unit to the d.c. motor, or from the energy source to the motor control unit.

6. The drive arrangement of claim 1 including and in combination with a light electric vehicle (LEV), an electric bicycle, a pedelec (pedal electric cycle), or an E-bike.

7. The drive arrangement of claim 1 including and in combination with a powered vehicle, a one-track or two-track powered vehicle, an electric scooter, an invalid carriage, a moped, a motor cycle, or a car.

8. The drive arrangement of claim 2, including the co-axial cable transmitting voltages from 0 to 100 V.

9. The drive arrangement of claim 2 wherein the energy source for electrical energy includes a battery, a storage battery, or a generator.

10. The drive arrangement of claim 3 wherein the energy source for electrical energy includes a battery, a storage battery, or a generator.

11. The drive arrangement of claim 4, wherein the storage battery comprises a nickel metal hybrid storage battery, a nickel-cadmium storage battery, a lead storage battery, or a lithium-ion storage battery.

12. The drive arrangement of claim 9, wherein the storage battery comprises a nickel metal hybrid storage battery, a nickel-cadmium storage battery, a lead storage battery, or a lithium-ion storage battery.

13. The drive arrangement of claim 10, wherein the storage battery comprises a nickel metal hybrid storage battery, a nickel-cadmium storage battery, a lead storage battery, or a lithium-ion storage battery.

14. The drive arrangement of claim 4, including a motor control unit, the co-axial cable transmitting data in the form of high frequency signals from the motor control unit to the d.c. motor, or from the energy source to the motor control unit.

15. The drive arrangement of claim 12, including a motor control unit, the co-axial cable transmitting data in the form of high frequency signals from the motor control unit to the d.c. motor, or from the energy source to the motor control unit.

16. The drive arrangement of claim 13, including a motor control unit, the co-axial cable transmitting data in the form of high frequency signals from the motor control unit to the d.c. motor, or from the energy source to the motor control unit.

17. The drive arrangement of claim 2 including and in combination with a light electric vehicle (LEV), an electric bicycle, a pedelec (pedal electric cycle), or an E-bike.

18. The drive arrangement of claim 3 including and in combination with a light electric vehicle (LEV), an electric bicycle, a pedelec (pedal electric cycle), or an E-bike.

19. The drive arrangement of claim 4 including and in combination with a light electric vehicle (LEV), an electric bicycle, a pedelec (pedal electric cycle), or an E-bike.

20. The drive arrangement of claim 2 including and in combination with a powered vehicle, a one-track or two-track powered vehicle, an electric scooter, an invalid carriage, a moped, a motor cycle, or a car.

21. The drive arrangement of claim 3 including and in combination with a powered vehicle, a one-track or two-track powered vehicle, an electric scooter, an invalid carriage, a moped, a motor cycle, or a car.

22. The drive arrangement of claim 4 including and in combination with a powered vehicle, a one-track or two-track powered vehicle, an electric scooter, an invalid carriage, a moped, a motor cycle, or a car.
